(19) United States
(12) Patent Application Publication
(10) Pub. No.: US 2026/0081494 A1
(43) Pub. Date: Mar. 19, 2026

(54) HAIRPIN CONFIGURATION OF ELECTRIC MACHINE

(71) Applicant: FCA US LLC, Auburn Hills, MI (US)

(72) Inventors: Reemon Haddad, Auburn Hills, MI (US); Dhafar Al-Ani, Auburn Hills, MI (US)

(21) Appl. No.: 18/887,511

(22) Filed: Sep. 17, 2024

(51) Int. Cl. H02K 3/14; H02K 3/28

(52) U.S. Cl. CPC H02K 3/14; H02K 3/28

(57) ABSTRACT

An electric machine includes a stator stack and a plurality of hairpin windings. The stator stack has an outer radial surface and an inner radial surface, the inner radial surface defines a plurality of slots thereon, the stator stack defines an axial stack thickness. The plurality of hairpin windings are received at the plurality of slots, wherein each hairpin of the plurality of hairpin windings includes a central body portion received in the stator stack at the axial stack thickness, a first end winding portion that extends out of a first end of the stator stack, and a second end winding portion that extends out of a second end of the stator stack. The central body portion defines a first thickness, the first end portion defines a second thickness and the second end portion defines a third thickness, wherein the second thickness is less than the first thickness.

### FIELD

The present application relates generally to electric machines and, more particularly, to a hairpin winding configuration used in the electric machine to enhance performance and efficiency.

### BACKGROUND

Different types of electric vehicles, including mild hybrid electric vehicles (mHEV's), plug-in hybrid electric vehicles (PHEV's), battery electric vehicles (BEV's), and range extended battery electric vehicles (REEV's), rely on electric machines for propulsion as a main source of torque, which generates the necessary power for vehicle propulsion. Hairpin winding is a technique used in electric machines to enhance performance and efficiency. It involves using a conductive (e.g., copper) wire shaped like hairpins and inserting them into slots defined in the stator. The configuration of these hairpins contribute to heat dissipation characteristics of the electric machine as a whole. In many instances, the configuration of the hairpins do not optimize heat dissipation, reduce copper losses and provide desired power density. In this regard, while existing hairpin winding configurations can be satisfactory, there remains a need for improvement in the relevant art.

### SUMMARY

In accordance with one example aspect of the invention, an electric machine includes a stator stack and a plurality of hairpin windings. The stator stack has an outer radial surface and an inner radial surface, the inner radial surface defines a plurality of slots thereon, the stator stack defines an axial stack thickness. The plurality of hairpin windings are received at the plurality of slots, wherein each hairpin of the plurality of hairpin windings includes a central body portion received in the stator stack at the axial stack thickness, a first end winding portion that extends out of a first end of the stator stack, and a second end winding portion that extends out of a second end of the stator stack. The central body portion defines a first thickness, the first end portion defines a second thickness and the second end portion defines a third thickness, wherein the second thickness is less than the first thickness.

In examples, the third thickness is less than the first thickness.

In examples, the first end winding portion comprises a welding side of the plurality of hairpin windings.

In other examples, the second end winding portion comprises a twisting side of the plurality of hairpin windings.

In other implementations, six hairpin windings are disposed in a slot of the plurality of slots defined in the stator stack.

In examples, eight hairpin windings are disposed in a slot of the plurality of slots defined in the stator stack.

In other examples, the plurality of hairpin windings are formed of copper.

In additional implementations, the electric machine comprises an interior permanent magnet electric machine.

In other examples, the electric machine comprises a surface-mounted permanent magnet electric machine.

In additional examples, the electric machine comprises an induction machine.

In examples, the electric machine comprises an externally excited synchronous machine.

In other configurations, the electric machine comprises a wound-field synchronous machine.

In additional examples, the first thickness comprises distinct thicknesses at distinct cross-sectional areas of the central body portion.

In other arrangements, the second thickness comprises distinct thicknesses at distinct cross-sectional areas of the first end winding portion.

In other examples, the third thickness comprises distinct thicknesses at distinct cross-sectional areas of the second end winding portion.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a side view of an electric machine stator with hairpin windings according to one prior art example;

FIG. 2 is a sequence view illustrating an exemplary assembly process of assembling the hairpin windings into the electric machine stator of FIG. 1;

FIG. 3A is a sectional view of an exemplary stator illustrating a hairpin configuration having eight conductors per slot according to one example of the present disclosure;

FIG. 3B is a detail view of a portion FIG. 3A in accordance with the principles of the present disclosure;

FIG. 3C is a sectional view of an exemplary stator illustrating a hairpin configuration having six conductors per slot according to one example of the present disclosure;

FIG. 3D is a detail view of a portion of the exemplary stator of FIG. 3C identified at 3D in accordance with the principles of the present disclosure;

FIG. 4A is a plan view of a conventional hairpin winding according to one prior art example;

FIG. 4B is a plan view of a hairpin winding constructed in accordance to one example of the present disclosure;

FIG. 5 is a perspective view of the hairpin winding of FIG. 4B in accordance with the principles of the present disclosure;

FIG. 5A is a detail view of a portion of the hairpin winding of FIG. 5 identified at 5A in accordance with the principles of the present disclosure; and

FIG. 5B is a detail view of a portion of the hairpin winding of FIG. 5 identified at 5B in accordance with the principles of the present disclosure.

### DETAILED DESCRIPTION

As noted above, the configuration of electric machine hairpins contribute to heat dissipation characteristics of the electric machine as a whole. In many instances, the configuration of the hairpins do not optimize heat dissipation, reduce copper losses and provide desired power density. For hybrid cooled (water jacket and oil) or oil cooled electric machines, the hairpin winding hot spot location is typically in the center of the stator stack, therefore the size of the hairpin cross-sectional area is designed based on that location. However, the end-winding section of the hairpin winding is cooled through oil splash and spray, and the temperature will not reach the maximum limit. In this regard, the end-winding temperature is always lower than the hot spot temperature. As a result, the cross-sectional area of the windings in the end-winding location is unnecessarily thick and over designed.

According to the principles of the present application, a new hairpin configuration is disclosed that provides distinct cross-sectional areas at the hairpin end windings compared to the area of the hairpins in the center of the stator stack. The cross-sectional area of the hairpins inside the stator stack is larger than the cross-sectional area of the hairpins outside the stator stack (e.g., at the end winding sections). The hairpin configuration disclosed herein reduces the overall winding mass and therefore cost without sacrificing performance. Additionally, the proposed hairpin configuration will reduce the overall heat losses, improving the efficiency of the electric machine, electromagnetic performance and thermal performance.

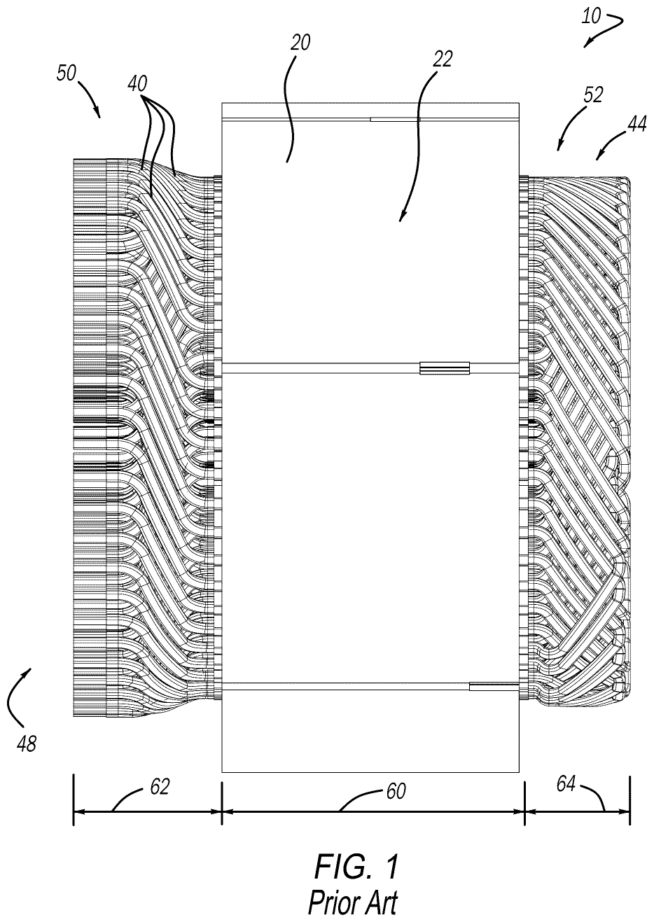

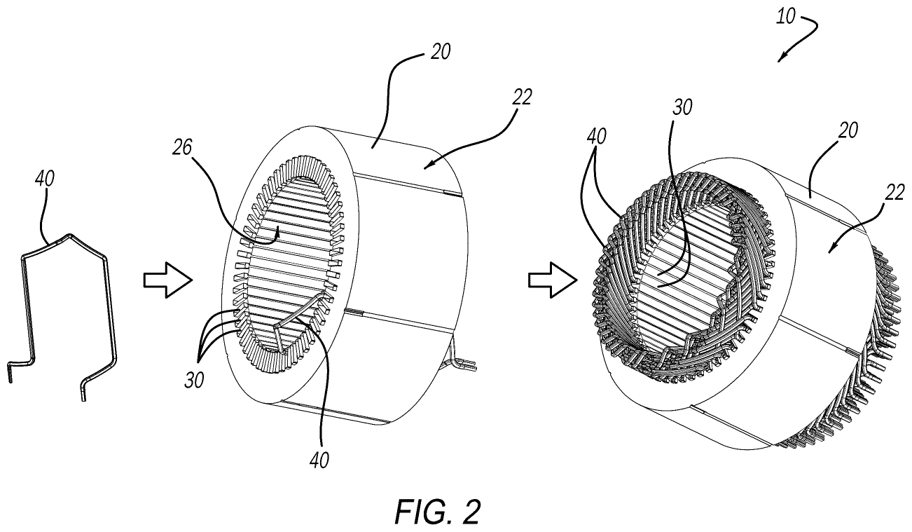

With initial reference to FIGS. 1 and 2, an electric machine stator 10 is shown according to one prior art example. The stator 10 generally includes a stator stack 20 that includes an outer radial surface 22 and an inner radial surface 26. The stator stack 20 can be formed by a collection of thin sheets that are stacked together to form a core of the stator 10. The inner surface 26 defines a plurality of stator slots 30 configured to receive a plurality of hairpins 40. The plurality of hairpins 40 collectively define a hairpin winding 44. The hairpin winding 44 generally extends out of the stator stack 20 as end-windings 48. The end-windings 48 are also referred to on a first end as a welding side 50 and on a second end as a twisting side 52. In one non-limiting example, the stator stack 20 defines a thickness 60, the welding side 50 of the end windings 48 defines a thickness 62, and the twisting side 52 of the end windings 48 defines a thickness 64. In one example, the thickness 62 is about 60% of the thickness 60, while the thickness 64 is about 40% of the thickness of 60. Other configurations are contemplated.

With particular reference to FIG. 2, a typical process of assembling the hairpins 40 into the stator stack 20 includes first, wire (hairpin) preparation and forming. Next, the hairpins 40 are inserted into the stator stack 20. Next, the hairpins 40 are twisted at the twisting side 52. Finally, the hairpins 40 are cut or trimmed and welded (e.g., laser, tig, braze, etc.) at the welding side 50.

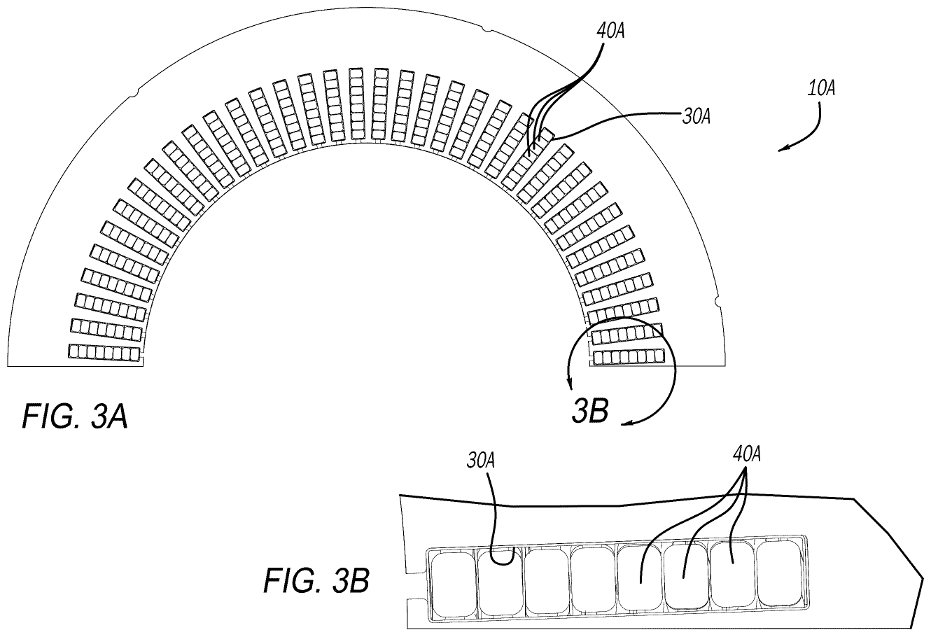

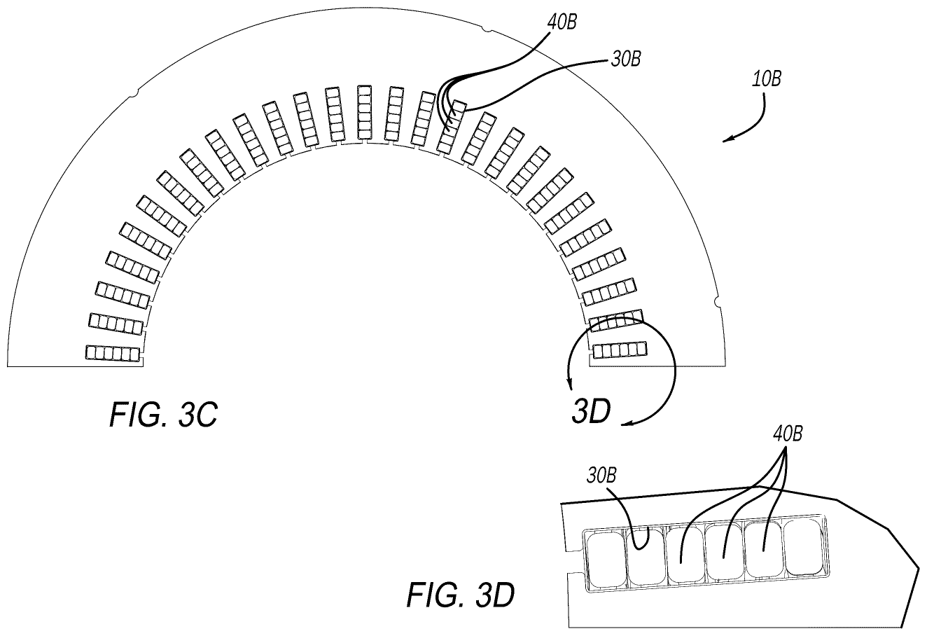

FIG. 3A is a sectional view of an exemplary stator 10A illustrating a hairpin configuration having eight conductors (wires) 40A per slot 30A according to one example. FIG. 3C is a sectional view of an exemplary stator 10B illustrating a hairpin configuration having six conductors (wires) 40B per slot 30B according to one example. The configurations shown in FIGS. 3A-3D are merely exemplary. Detail views of the exemplary stator 10A and 10B are shown at FIGS. 3B and 3D. Other configurations having different amounts of conductors per slot are contemplated.

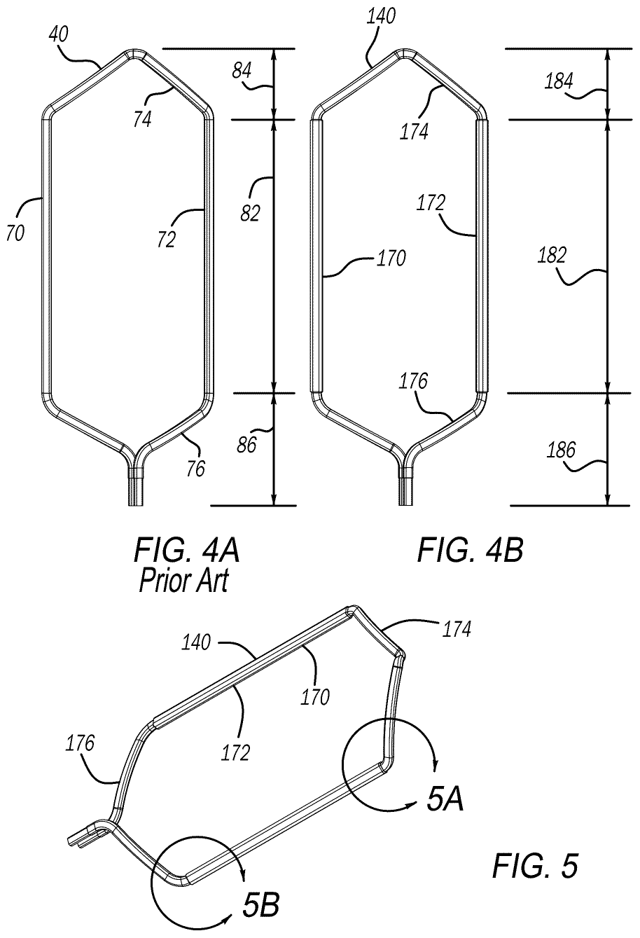

With additional reference now to FIGS. 4A and 4B a comparison between a hairpin 40 constructed in accordance to prior art (FIG. 4A) and a hairpin 140 constructed in accordance to one example of the present disclosure (FIG. 4B) will be described. Unless otherwise described herein, the hairpin 140 can be configured to be installed in the slots 30 of the stator stack 20 described above. In this regard, the hairpin 140 can be configured for use in any of the stator configurations described herein.

The hairpin 40, constructed in accordance to one prior art example, generally includes a hairpin body 70 having a central body portion 72, a first end winding portion 74 and a second end winding portion 76. The central body portion 72 generally extends a central distance 82 inside the stator stack 20. The first end winding portion 74 generally extends a first distance 84 outside the stator stack 20. The second end winding portion 76 generally extends a second distance 86 outside the stator stack 20. The thickness of the hairpin 40 is consistent throughout the central body portion 72, the first end winding portion 74 and the second end winding portion 76.

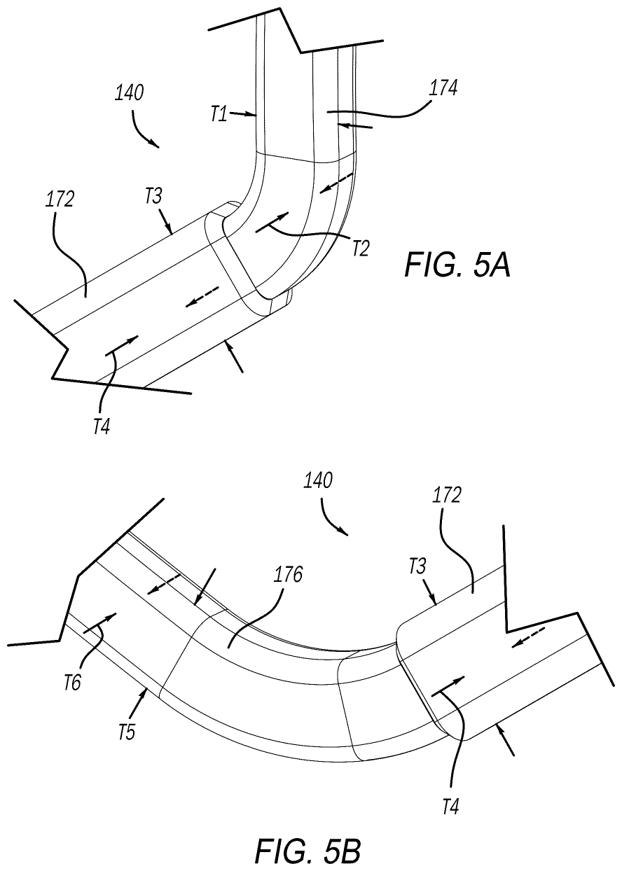

With particular reference now to FIGS. 4B-5B, the hairpin 140 will be further described. The hairpin 140 generally includes a hairpin body 170 having a central body portion 172, a first end winding portion 174 and a second end winding portion 176. The central body portion 172 generally extends a central distance 182 inside the stator stack (such as stator stack 20). The first end winding portion 174 generally extends a first distance 184 outside the stator stack. The second end winding portion 176 generally extends a second distance 186 outside the stator stack.

The thickness of the hairpin 140 is distinct at the first and second end winding portions 174, 176 compared to the central body portion 172. In particular, the thickness of the hairpin 140 at the first and second end winding portions 174, 176 is reduced (less than) compared to the thickness of the hairpin 140 at the central body portion 172. With particular reference to FIG. 5A, the first end winding portion 174 defines a first and second thickness T1, T2. The first and second thicknesses T1 and T2 are defined at distinct cross-sectional areas of the first end winding portion 174. The central body portion 172 defines a third and fourth thickness T3, T4. The third and fourth thicknesses T3 and T4 are defined at distinct cross-sectional areas of the central body portion 172. The second end winding portion 176 defines a fifth and sixth thickness T5, T6. The fifth and sixth thicknesses T5 and T6 are defined at distinct cross-sectional areas of the second end winding portion 176.

In the example shown, the thicknesses T1 and T5 of the respective first and second end winding portions 174 and 176 are less than a corresponding thickness T3 of the central body portion 172. Similarly, the thicknesses T2 and T6 of the respective first and second end winding portions 174 and 176 are less than a corresponding thickness T4 of the central body portion 172. The cross-sections of the hairpin 140 can be optimized at the end windings and the stator stack based on electric machine design, application, and cooling method used. In one non-limiting example, the overall mass of the hairpin can be reduced by about 5% contributing to a significant reduction in cost.

The hairpin 140 provides many advantages over prior art hairpins such as hairpin 40. For example, because the thickness of the first and second end winding portions 174 and 176 is reduced (compared to a thickness of the central body portion), overall mass is reduced, efficiency is improved, a higher power to weight ratio is realized, material cost is reduced, mobility is enhanced and packaging space is reduced. Moreover, copper losses are reduced, heat dissipation and power density are improved. The configuration of the hairpin 140 also enables easier manufacturing and assembly processes.

The hairpin 140 can be applied for all types of electric machines such as, but not limited to, interior permanent magnet (IPM), surface-mounted permanent magnet (SMPM), induction machine (IM), externally excited synchronous machine (EESM), wound-field synchronous machine (WFSM), and others. The hairpin 140 can be applied for a stator having an “I” pin, a “U” pin, or both “I”and “U”pin windings.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electric machine, comprising:
a stator stack having an outer radial surface and an inner radial surface, the inner radial surface defining a plurality of slots thereon, the stator stack defining an axial stack thickness;
a plurality of hairpin windings received at the plurality of slots, wherein each hairpin of the plurality of hairpin windings includes a central body portion received in the stator stack at the axial stack thickness, a first end winding portion that extends out of a first end of the stator stack, and a second end winding portion that extends out of a second end of the stator stack; and
wherein the central body portion defines a first thickness, the first end portion defines a second thickness and the second end portion defines a third thickness, wherein the second thickness is less than the first thickness.

2. The electric machine of claim 1, wherein the third thickness is less than the first thickness.

3. The electric machine of claim 1, wherein the first end winding portion comprises a welding side of the plurality of hairpin windings.

4. The electric machine of claim 1, wherein the second end winding portion comprises a twisting side of the plurality of hairpin windings.

5. The electric machine of claim 1, wherein six hairpin windings are disposed in a slot of the plurality of slots defined in the stator stack.

6. The electric machine of claim 1, wherein eight hairpin windings are disposed in a slot of the plurality of slots defined in the stator stack.

7. The electric machine of claim 1, wherein the plurality of hairpin windings are formed of copper.

8. The electric machine of claim 1, wherein the electric machine comprises an interior permanent magnet electric machine.

9. The electric machine of claim 1, wherein the electric machine comprises a surface-mounted permanent magnet electric machine.

10. The electric machine of claim 1, wherein the electric machine comprises an induction machine.

11. The electric machine of claim 1, wherein the electric machine comprises an externally excited synchronous machine.

12. The electric machine of claim 1, wherein the electric machine comprises a wound-field synchronous machine.

13. The electric machine of claim 1, wherein the first thickness comprises distinct thicknesses at distinct cross-sectional areas of the central body portion.

14. The electric machine of claim 13, wherein the second thickness comprises distinct thicknesses at distinct cross-sectional areas of the first end winding portion.

15. The electric machine of claim 14, wherein the third thickness comprises distinct thicknesses at distinct cross-sectional areas of the second end winding portion.
